(19) United States
(12) Patent Application Publication
(10) Pub. No.: US 2008/0020795 A1
(43) Pub. Date: Jan. 24, 2008

(54) APPARATUS AND METHOD FOR SELECTING A SHOOTING MODE

(75) Inventor: Dae-Hyun KIM, Gumi-si (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-si (KR)

(21) Appl. No.: 11/746,617

(22) Filed: May 9, 2007

(30) Foreign Application Priority Data
Jul. 18, 2006 (KR) 2006-66925

(51) Int. Cl. H04M 1/00; G03B 7/00

(52) U.S. Cl. 455/556.1; 396/65

(57) ABSTRACT

An apparatus and method for selecting a shooting mode in a mobile terminal having a distance measurement unit for measuring the distance between a camera and an object are provided. The apparatus and method include a distance measurement unit for measuring a distance between the camera and the object when the mobile terminal enters a camera mode for photographing the object and a controller for selecting a shooting mode according to the measured distance. The mobile terminal selects an appropriate shooting mode according to the measured distance between the camera and the object, thereby enhancing the user's convenience. Also, the mobile terminal informs the user of the optimum distance in the selected shooting mode so that the user can take high-quality pictures.

### PRIORITY

This application claims the benefit under 35 U.S.C. §119(a) of a Korean patent application filed in the Korean Intellectual Property Office on Jul. 18, 2006 and assigned Serial No. 2006-66925, the entire disclosure of which is hereby incorporated by reference.

### BACKGROUND OF THE INVENTION

1. Field of the Invention

The present invention relates to a mobile terminal having a camera function. More particularly, the present invention relates to a mobile terminal apparatus and method for automatically selecting a shooting mode according to a distance from a camera to an object.

2. Description of the Related Art

Recently, mobile terminals have been provided with multimedia and other functions and have gone beyond merely being devices for voice communication. For example, mobile terminals are now able to perform high-speed data transmission. IMT-2000 mobile communication network services enable such high-speed data transmission as well as voice communication through mobile terminals. In an IMT-2000 network, mobile terminals process both packet data and image data which allow high-speed data and image transmission. As another example, mobile terminals are now equipped with an embedded camera. Such mobile terminals can take pictures and can send the pictures to another mobile terminal over the communication network. Also, mobile terminals with a camera or a TV receiver can display pictures as still or motion pictures. Mobile terminals with a camera also generally offer a zoom function for gradually reducing or enlarging the size of an image.

To photograph an object using a mobile terminal with a camera, users must directly select a desired shooting mode, for example, a close-up mode, a portrait mode or a landscape mode. When an incorrect mode is selected inadvertently, the user must try again to select the desired mode and retake the photograph.

Furthermore, it is often the case that users fail to take a high-quality picture due to an improper adjustment of the camera-to-object distance even in the properly selected shooting mode and must make several attempts in order to obtain a high-quality picture.

### SUMMARY OF THE INVENTION

Accordingly, the present invention has been made to address the above-mentioned problems and/or disadvantages occurring in the prior art, and an aspect of the present invention is to provide a mobile terminal apparatus and method for automatically selecting a shooting mode when a camera mode is executed.

Another object of the present invention is to provide a mobile terminal apparatus and method for informing of an optimum shooting distance in each selected shooting mode when a camera mode is executed.

In accordance with an aspect of the present invention, a method for automatically selecting a shooting mode in a mobile terminal having a distance measurement unit for measuring the distance between a camera and an object is provided. The method includes activating a distance measurement unit to measure the distance between the camera and the object when the mobile terminal enters a camera mode for photographing the object and selecting a shooting mode according to the measured distance.

In accordance with another aspect of the present invention, a mobile terminal is provided. The mobile terminal includes a camera for photographing an object, a distance measurement unit for measuring a distance between the camera and the object and a control unit for selecting a shooting mode according to the distance measure by the distance measurement unit.

In an exemplary embodiment, the mobile terminal further includes an output unit for outputting a message informing of the automatically selected shooting mode under the control of the control unit.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a rear view of a mobile terminal according to an exemplary embodiment of the present invention;

FIG. 2 is a block diagram illustrating a mobile terminal according to an exemplary embodiment of the present invention;

FIG. 3 is a flowchart illustrating an operation of a mobile terminal for photographing an object according to an exemplary embodiment of the present invention; and

FIG. 4 is a flowchart illustrating a process of automatically selecting a shooting mode according to a measured camera-to-object distance during the exemplary operation in FIG. 3.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

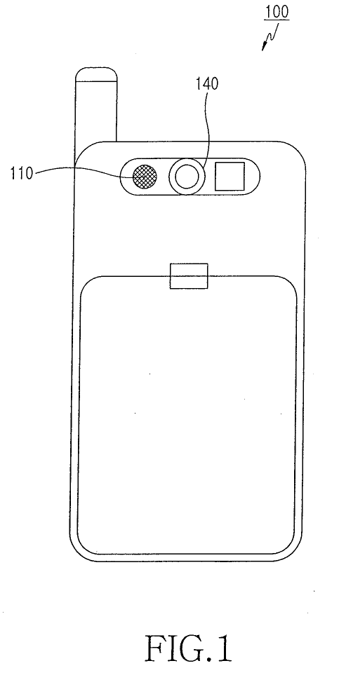

FIG. 1 illustrates a rear view of a mobile terminal according to an exemplary embodiment of the present invention.

Referring to FIG. 1, a mobile terminal 100 has a camera 140 mounted at a top portion of a main body. The mobile terminal 100 also includes a distance measurement unit 110 for measuring a distance between the camera 140 and an object. In an exemplary embodiment, the distance measurement unit 110 is provided alongside the camera 140 and the distance measurement unit 140 comprises an ultrasonic sensor. However, the distance measurement unit 140 may be located elsewhere on the terminal 100 and may comprise any appropriate technology for measuring distances. If an ultrasonic sensor is used, the ultrasonic sensor transmits ultrasonic waves to a target and determines a distance-to-target by measuring the time required for return of the reflected ultrasonic waves. Since the distance determination using an ultrasonic sensor is generally known in the art, no further explanation will be made.

Although not illustrated in the drawings, the mobile terminal 100 may also include camera operating keys, such as a camera on/off key used to enter a camera mode, a zoom key and a shutter key used to take a photograph. Such keys may be located on a lateral side of the main body or elsewhere on the terminal.

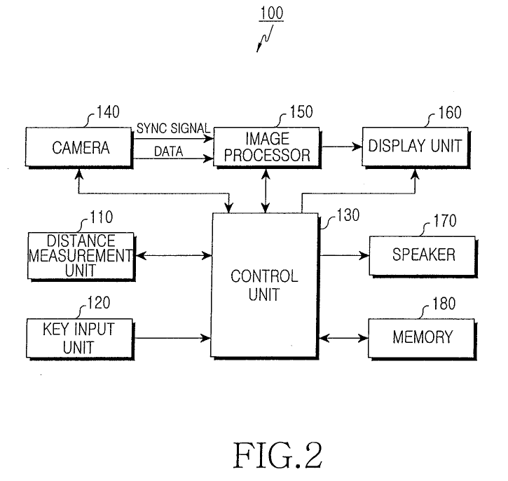

FIG. 2 is a block diagram illustrating a mobile terminal according to an exemplary embodiment of the present invention.

The mobile terminal 100 includes a distance measurement unit 110, a key input unit 120, a control unit 130, a camera 140, an image processor 150, a display unit 160, a speaker 170 and a memory 180. Both the display unit 160 and the speaker 170 act as output units.

As stated above, the distance measurement unit 110 can be an ultrasonic sensor according to an exemplary embodiment of the present invention. When the mobile terminal 100 enters a camera mode, the distance measurement unit 110 measures a distance from the camera 140 to an object, and outputs information on the measured distance to the control unit 130.

The key input unit 120 is provided with alphanumeric keys, various function keys and volume keys. The key input unit 120 outputs an input signal corresponding to a key selected by the user to the control unit 130. In an exemplary embodiment, the key input unit 120 may be further provided with camera operating keys, such as a camera on/off key used to enter a camera mode, a zoom key used to adjust the image size, and a shutter key used to take a photograph. The key input unit is included at a location on the main body of the terminal 100.

The control unit 130 controls overall operation of the mobile terminal 100. When the user inputs a key to enter a camera mode, the control unit 130 changes the current operation mode of the mobile terminal 100 to the camera mode. In the camera mode, the control unit 130 controls the distance measurement unit 110 to measure a distance between the camera 140 and an object.

The control unit 130 selects a shooting mode appropriate for the object according to the measured distance. In an exemplary embodiment, the control unit 130 may output a voice or text message to the speaker 170 or the display unit 160 in order to inform the user of the selected shooting mode. The shooting mode can be a close-up mode, a portrait mode, a landscape mode or the like. In another exemplary embodiment, the shooting mode is automatically selected by the control unit 130.

In an exemplary embodiment, reference information correlating a camera-to-object distance to a shooting mode, as shown in Table 1, is stored in the memory 180. If the reference information is stored, the control unit 130 can automatically select an appropriate shooting mode according to the measured distance.

TABLE 1

| Shooting mode | Close-up mode | Portrait mode | Landscape mode |
|---|---|---|---|
| Distance | Shorter than 1^{st} | Between 1^{st} | Longer than 2^{nd} |
| | reference distance | reference distance | reference distance |
| | | and 2^{nd} reference | |
| | | distance | |

In the exemplary embodiment as shown in Table 1, three shooting modes are selectable. The mobile terminal selects a close-up mode when the camera-to-object distance is shorter than a first reference distance (for example, 10 cm), a portrait mode when the camera-to-object distance is between the first reference distance and a second reference distance (for example, 3 m), and a landscape mode when the camera-to-object distance is longer than the second reference distance. Of course, the distances or 10 cm and 3 m are merely exemplary and other distances may be used as the first and second references distances respectively.

Furthermore, the first and second reference distances in Table 1 can vary depending on the number of pixels of the camera (for example, the reference distances can be increased with an increased number of pixels). Of course, the second reference distance is greater than the first reference distance. In an exemplary embodiment, close-up pictures cannot be taken at a distance equal to or greater than the first reference distance, and portrait pictures cannot be taken at a distance equal to or greater than the second reference distance.

When a shutter key is pressed, the control unit 130 controls the camera 140 to photograph the object using the selected shooting mode.

In an exemplary embodiment, the camera 140 has a lens (not shown) capable of zooming in and out. The camera 140 also may comprise a camera sensor (not shown) for converting a photographed optical signal into an electrical signal and a signal processor (not shown) for converting an analog image signal photographed by the camera into digital data.

An exemplary camera sensor comprises a charge coupled device (CCD) sensor, and an exemplary signal processor comprises a digital signal processor (DSP). Of course, other sensors and signal processors may be employed, for example a complementary metal oxide semiconductor (CMOS) image sensor. The camera sensor and signal processor can be either integrated into a single element, or provided separately as independent elements.

The image processor 150 generates picture data for displaying an image signal output from the camera 140.

Specifically, the image processor 150 processes image signals obtained from the camera 140 in frames. Also, the image processor 150 adjusts the frame image data to conform to certain features, such as size and resolution, which are displayable on the display unit 160, and outputs the adjusted frame image data. The image processor 150 may comprise an image codec to compress the frame image data displayed on the display unit 160 in a preset manner or restore the compressed frame image data to the original frame image data.

The image processor 150 has an on screen display (OSD) function and can output OSD data according to the displayed picture size under control of the control unit 130.

The display unit 160 outputs various display data generated by the mobile terminal 100. The display unit 160 may comprise a liquid crystal display (LCD). When the LCD is a touch screen display, it can also serve as an input device.

The display unit 160 displays image data output from the image processor 150 and user data supplied from the control unit 130.

The memory 180 may be composed of a program memory and a data memory. The memory 180 stores programs for controlling general operations of the mobile terminal 100 and various information selected by the user. In accordance with an exemplary embodiment of the present invention, the memory 180 also stores information regarding a reference distance for each shooting mode as shown in Table 1 to enable the control unit 130 to automatically select an appropriate shooting mode according to a distance from the camera 140 to the object. The data and programs stored in the memory 180, including reference information regarding distances such as that shown in Table 1, may be set at a factory and may be alterable by a user.

If the mobile terminal 100 has a mobile communication function, it may further comprise an RF transceiver (not shown) for transmitting and receiving audio, text, image and control data under the control of the control unit 130. The RF transceiver comprises an RF transmitter for performing upward conversion and amplification of a transmitted signal and an RF receiver for amplifying a received signal with low noise and performing downward conversion of the signal.

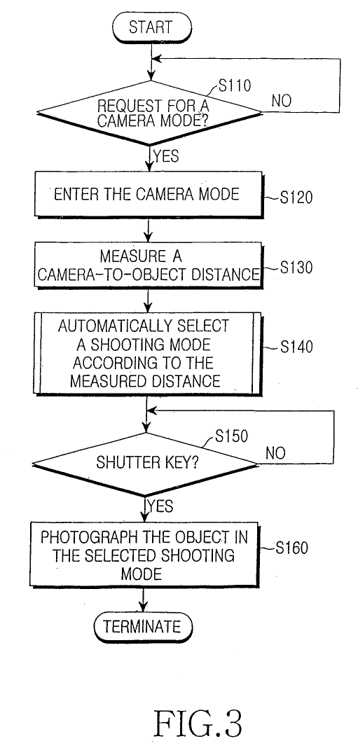

FIG. 3 is a flowchart illustrating an operation of a mobile terminal for photographing an object according to an exemplary embodiment of the present invention.

Referring to FIG. 3, the control unit 130 determines whether a request to enter a camera mode is inputted in step S110. The user can input the request by selecting a corresponding menu or pressing a camera on/off key provided on the mobile terminal 100.

Upon detecting the request, the control unit 130 converts the current operation mode of the mobile terminal 100 to the camera mode for photographing in step S120.

When the camera mode is implemented, the control unit 130 controls the distance measurement unit 110 to measure a distance between the camera 140 and an object in step S130.

The control unit 130 selects an appropriate shooting mode according to the measured distance in step S140. The shooting mode can be one of a close-up mode, a portrait mode and a landscape mode. At this time, the control unit 130 may detect a shooting mode corresponding to the measured distance from the reference distance information stored in the memory 180 and select the detected shooting mode. Also, the control unit 130 may output a message informing the user of the selected shooting mode.

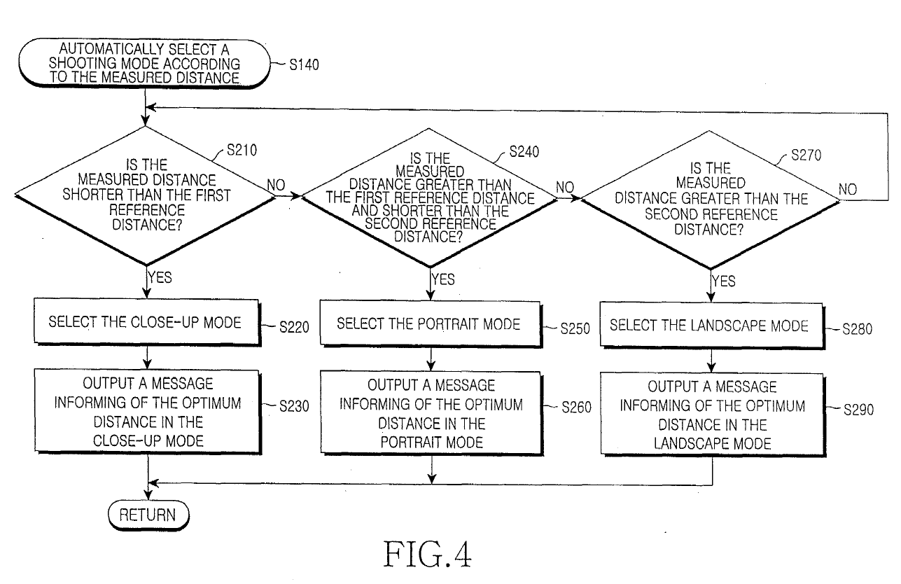

The process of automatically selecting a shooting mode according to the measured distance as illustrated in step S140 will now be explained in more detail with reference to FIG. 4.

The control unit 130 determines whether the measured distance is shorter than a first reference distance (for example, 10 cm) in step S210. The first reference distance is a distance at which close-up pictures cannot be taken.

When the measured distance is shorter than the first reference distance, the control unit 130 selects the close-up mode as the appropriate shooting mode in step S220. In other words, when the measured distance is shorter than the first reference distance, the control unit 130 determines that the user wishes to capture a close shot, and thereby selects the close-up mode.

The control unit 130 then outputs a message informing of an optimum distance to the object in the close-up mode to the display unit 160 or the speaker 170 in step S230. For example, the control unit 130 may output a voice message “Move one step back” to the speaker 170 or a corresponding text message to a preview screen of the display unit 160 when the measured distance between the camera and the object is shorter than the optimum distance. The control unit 130 may output a message “Move one step forward” when the measured distance is greater than the optimum distance. The control unit 130 may output a message “Good! Smile˜” when the measured distance is optimum. In an exemplary embodiment, the control unit 130 displays the distance between the camera 140 and the object in real time on the preview screen of the display unit 160.

If the control unit 130 determines that the measured distance is not shorter than the first reference distance in step S210, it will then determine whether the measured distance is between the first reference distance (for example, 10 cm) and a second reference distance (for example, 3 m) in step S240. The second reference distance is a distance which is too long to take portrait pictures but appropriate to take landscape pictures.

When the measured distance is greater than the first reference distance and shorter than the second reference distance, the control unit 130 selects the portrait mode as the appropriate shooting mode in step S250.

The control unit 130 then outputs a message informing of the optimum distance to the object in the portrait mode to the display unit 160 or the speaker 170 in step S260. The message can be the same as that output in step S230.

If the control unit 130 determines that the measured distance is not between the first reference distance and the second reference distance in step S240, it will then determine whether the measured distance is greater than the second reference distance in step S270.

When the measured distance is greater than the second reference distance, the control unit 130 selects the landscape mode as the appropriate shooting mode in step S280.

The control unit 130 then outputs a message informing of the optimum distance to the object in the landscape mode to the display unit 160 or the speaker 170 in step S290. The message can be the same as that output in steps S230 or S260.

After selecting an appropriate shooting mode through the process depicted in FIG. 4, the control unit 130 determines whether the shutter key is pressed to capture an image in step S150.

When the shutter key is pressed, the control unit 130 controls the camera 140 to photograph the object in the selected shooting mode in step S160. If the shutter key is not pressed, the control unit 130 continues to wait for such an input.

As explained above, a mobile terminal according to an exemplary embodiment of the present invention selects an appropriate shooting mode according to a measured distance between the camera and the object, thereby enhancing the user's convenience. Also, the mobile terminal informs the user of the optimum distance in the selected shooting mode so that the user can take high-quality pictures.

Although a mobile terminal having a camera has been explained above, the technique for automatically selecting a shooting mode according to the present invention is also applicable to a digital camera.

Although exemplary embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for selecting a shooting mode in a mobile terminal, the method comprising:
entering into a photographing mode;
activating a distance measurement unit to measure a distance between a camera and an object; and
selecting a shooting mode according to the measured distance.

2. The method according to claim 1, wherein said selecting of the shooting mode comprises automatically selecting the shooting mode.

3. The method according to claim 1, wherein said distance measurement unit comprises an ultrasonic sensor.

4. The method according to claim 1, wherein the selecting of the shooting mode comprises outputting a message informing of the selected shooting mode.

5. The method according to claim 1, wherein said shooting mode comprises at least one of a close-up mode, a portrait mode and a landscape mode.

6. The method according to claim 5, wherein said selecting of the shooting mode comprises selecting the close-up mode when the measured distance is shorter than a first distance.

7. The method according to claim 6, further comprising outputting a message informing of an optimum distance to the object in the close-up mode.

8. The method according to claim 5, wherein said selecting of the shooting mode comprises selecting the portrait mode when the measured distance is greater than a first distance and shorter than a second distance.

9. The method according to claim 8, further comprising outputting a message informing of an optimum distance to the object in the portrait mode.

10. The method according to claim 5, wherein said selecting of the shooting mode comprises selecting the landscape mode when the measured distance is greater than a second distance.

11. The method according to claim 10, further comprising outputting a message informing of an optimum distance to the object in the landscape mode.

12. The method according to claim 1, further comprising displaying the measured distance between the camera and the object.

13. A mobile terminal comprising:
a camera for photographing an object;
a distance measurement unit for measuring a distance between the camera and the object; and
a control unit for selecting a shooting mode according to the distance measured by the distance measurement unit.

14. The mobile terminal according to claim 13, wherein the control unit automatically selects the shooting mode according to the distance measured by the distance unit.

15. The mobile terminal according to claim 13, wherein said distance measurement unit comprises an ultrasonic sensor.

16. The mobile terminal according to claim 13, further comprising an output unit for outputting a message informing of the selected shooting mode.

17. The mobile terminal according to claim 13, wherein said shooting mode comprises at least one of a close-up mode, a portrait mode and a landscape mode.

18. The mobile terminal according to claim 17, wherein said control unit selects the close-up mode when the measured distance is shorter than a first distance.

19. The mobile terminal according to claim 18, wherein said control unit outputs a message informing of an optimum distance to the object in the close-up mode.

20. The mobile terminal according to claim 17, wherein said control unit selects the portrait mode when the measured distance is greater than a first distance and shorter than a second distance.

21. The mobile terminal according to claim 20, wherein said control unit outputs a message informing of an optimum distance to the object in the portrait mode.

22. The mobile terminal according to claim 17, wherein said control unit selects the landscape mode when the measured distance is greater than a second distance.

23. The mobile terminal according to claim 22, wherein said control unit outputs a message informing of an optimum distance to the object in the landscape mode.

24. The mobile terminal according to claim 14, further comprising a display unit wherein said control unit controls the display unit to display the distance measured by the distance measurement unit.
